(19) United States
(12) Patent Application Publication
(10) Pub. No.: US 2016/0263850 A1
(43) Pub. Date: Sep. 15, 2016

(54) METHOD AND APPARATUS FOR FORMING AN ANNULAR ELASTOMERIC TIRE COMPONENT

(71) Applicant: The Goodyear Tire & Rubber Company, Akron, OH (US)

(72) Inventors: Richard David VARGO, Cuyahoga Falls, OH (US); Gary Robert BURG, Pawleys Island, SC (US); Brian Richard KOCH, Hartville, OH (US); Daniel Michael SPALLONE, Lyndhurst, OH (US)

(21) Appl. No.: 15/078,213

(22) Filed: Mar. 23, 2016

Related U.S. Application Data
(62) Division of application No. 13/478,553, filed on May 23, 2012, now abandoned.
(60) Provisional application No. 61/496,736, filed on Jun. 14, 2011.

(51) Int. Cl. B29D 30/62; B29D 30/48

(52) U.S. Cl. CPC B29D 30/62; B29D 30/48; B29D 2030/482

(57) ABSTRACT

A method of forming a tire apex and bead assembly is disclosed. The method and apparatus includes mounting a bead in a rotatable bead holder, rotating the bead and bead holder and extruding one or more passes of a continuous strip of elastomeric material onto the outer surface of the bead, and shaping the one or more passes of elastomeric material between two opposed rotating rollers.

This application claims the benefit of and incorporates by reference U.S. Provisional Application No. 61/496,736, filed Jun. 14, 2011.

### TECHNICAL FIELD

This invention relates to a method and apparatus for forming an annular bead apex or bead filler.

### BACKGROUND OF THE INVENTION

The invention relates to a method and apparatus of forming an annular bead apex and bead core subassembly. The bead apex is a rubber component that lies radially outward of an annular tensile member commonly referred to as a bead core. The shape of the bead apex is generally an elongated triangular shape resulting in a very long and thin delicate apex. The tire's carcass plies lie adjacent the radially inner surface of the bead apex and generally wrap around the bead core and extend along the axially outer surface of the bead apex in what is commonly referred to as the ply turnup.

When the tire is built flat, the apex must be turned 90° to an upright position. This forces the radially outermost tip of the bead apex to stretch circumferentially a larger amount than the innermost portion of the apex (next to the bead) resulting in high stresses and localized thinning of the bead apex.

It is difficult to manufacture bead apex subassemblies. As the apex shape becomes taller and thinner, the more difficult it is to manufacture because of the delicateness of the apex. One issue is ensuring the apex has sufficient adhesion to the bead wire. A large amount of force is typically needed to ensure there is a mechanical bond between the apex rubber and the bead. If a flat plate or other forming device is used to form the annular apex, then it is difficult to remove the formed apex from the plate due to adhesion. Attempts have been made to make uncured strips of bead apexes but the elongated tip of these apexes when formed into an annular ring tend to warp and buckle as the extrudate unevenly stretches and shrinks. This warping or buckling renders such parts useless. Accordingly, only very short squatty apexes lend themselves to this type of preforming. A third issue in manufacturing the apex and bead subassembly involves forming a splice of the apex.

Thus it is desired to provide a method and apparatus that can form an annular elastomeric strip such as an apex component without the unwanted stretching or warping of the tip. It is further desired to provide a method and apparatus for making an elongated apex or other strip of tire material in a profile oriented very close to the shape of the finished molded tire. It is further desired to provide a method for manufacturing multilayered components of different materials or multilayered components of similar material. It is also desired to provide a method that creates a smooth overlap of the beginning of an annular component and an end of the component such that the part appears seamless.

### DEFINITIONS

“Aspect ratio” of the tire means the ratio of its section height (SH) to its section width (SW);

“Axial” and “axially” means lines or directions that are parallel to the axis of rotation of the tire;

“Carcass” means the tire structure apart from the belt structure, tread, under tread, and sidewall rubber over the plies, but including the beads;

“Chafers” refers to narrow strips of material placed around the outside of the bead to protect cord plies from the rim, distribute flexing above the rim, and to seal the tire;

“Chippers” means a reinforcement structure located in the bead portion of the tire; and

“Cord” means one of the reinforcement strands of which the plies in the tire are comprised.

### BRIEF DESCRIPTION OF THE DRAWINGS

The invention will be described by way of example and with reference to the accompanying drawings in which:

FIG. 1 is a cross sectional view of a bead apex machine of the present invention.

FIG. 2 is a side view of the bead apex machine of FIG. 1.

FIG. 3a is a close-up side view of a portion of the apparatus shown in FIG. 1 of the present invention while forming the apex.

FIG. 3b is a close-up side view of FIG. 1 illustrating the motion of the shaping rollers in a fully formed apex.

FIG. 4 is a front view of a portion of the bead and bead holder showing a portion of the apex being formed by the rollers.

FIGS. 5 and 6 illustrate a second embodiment for forming an apex and bead subassembly.

FIG. 7 illustrates an apex and bead subassembly of the present invention. FIGS. 8 through 10 depict a third embodiment for forming a bead apex subassembly of the present invention.

### DETAILED DESCRIPTION OF THE INVENTION

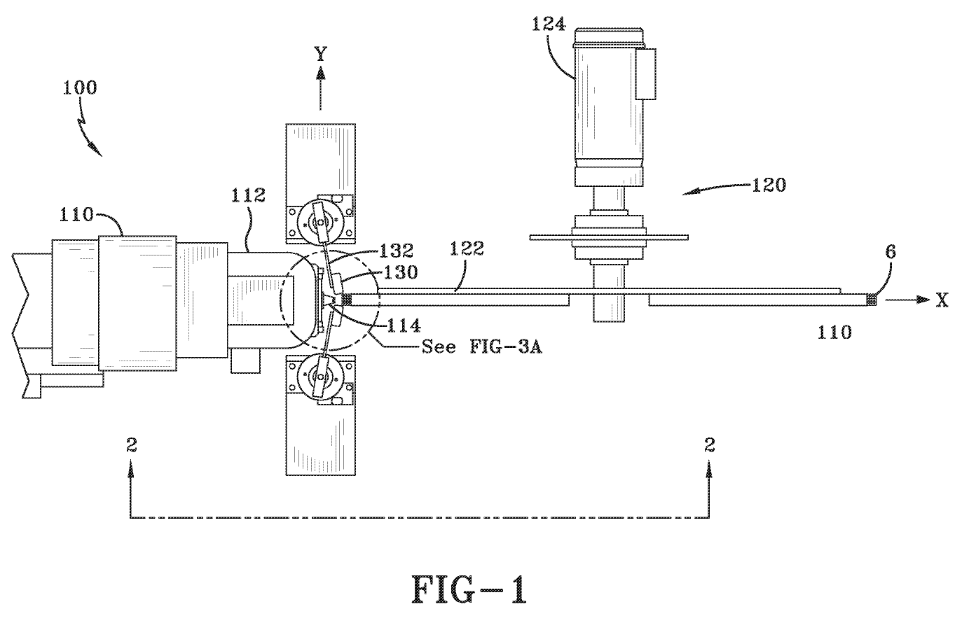

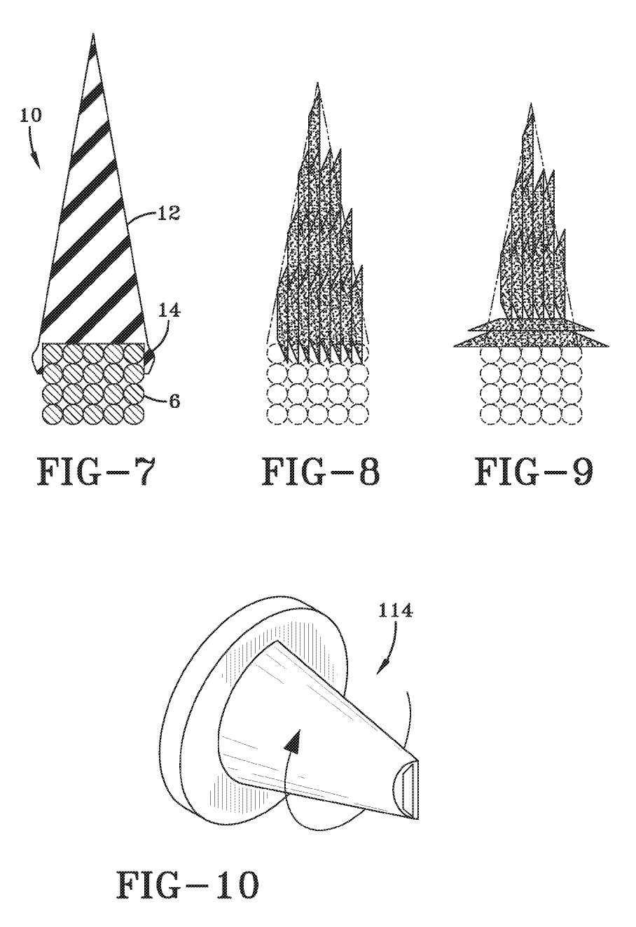

With reference to FIGS. 1 and 2, a machine 100 for forming an elastomeric annular component is shown. The invention is particularly suited for forming rubber tire components, and more particularly, a bead apex assembly. However, the invention is not limited to forming apexes, and could form annular elastomeric components. One example of a bead apex assembly 10 is illustrated in FIG. 7. As shown, the bead apex assembly 10 has a triangular shaped apex 12 made of elastomeric material. Radially inward of the bead apex is an annular tensile member commonly referred to as a metal bead core 6 formed of a plurality of bead wires. It is important that the elastomeric material forming the bead apex has impregnated the bead core 6 formings legs 14 which impregnate the bead. The apex is not limited to the cross-sectional shape of a triangle, and may be formed of any desired cross-sectional shape. The invention could also be used to form other annular tire components that do not have a bead core.

The machine 100 has an extruder means 110 for forming a continuous elastomeric strip 10, preferably formed of rubber. The extruder may comprise any commercial extruder suitable for processing of rubber or elastomer compounds. The extruder may comprise a commercially available extruder commonly known by those skilled in the art as a pin type extruder, a twin screw or a single screw extruder, or a ring type of extruder. One commercially available extruder suitable for use is a multicut transfermix (MCT) extruder, sold by VMI Holland BV, The Netherlands. Preferably, the extruder has an L/D of about 8, but may range from about 5 to about 25, preferably 10-15. A ring type, pin type or MCT type of extruder is preferred, but is not limited to same. The extruder functions to warm up the rubber compound to the temperature in the range of about 80° C. to about 150° C., preferably about 90° C. to about 120° C., and to masticate the rubber composition as needed. The extruder means 110 may be an extruder only, but is preferably an extruder in combination with a gear pump 112. The extruder or gear pump/extruder has an outlet end which preferably has a nozzle 114. The nozzle has an outlet orifice 116 having a desired profile shape for shaping the elastomeric material. The nozzle is positioned adjacent a bead holder 120. The bead holder 120 is configured to support the annular bead from its interior surface and to rotate the annular bead about its central axis. The bead holder 120 has an annular support device 122 which is rotatably mounted to a motor 124. The bead holder 120 functions to support and rotate the annular bead as an apex is formed on the outer surface. The bead holder 120 may translate incrementally in the Y direction to assist in even application of the elastomeric strip onto the bead.

Located adjacent the bead holder is one or more shaping rollers 130. Each shaping roller 130 is rotatably mounted on a support arm 132 for rotation about a transverse axis X′. Each shaping roller is independently movable with respect to the other shaping roller. The shaping arm 132 is mounted so that it can translate the roller in the X′ direction and pivot the shaping rollers about its longitudinal or Y′ axis, which is transverse to the X′ axis. The shaping rollers can pivot +−90 degrees about the Y′ axis. The roller has an outer surface 134 for contacting the apex which is flat with rounded edges.

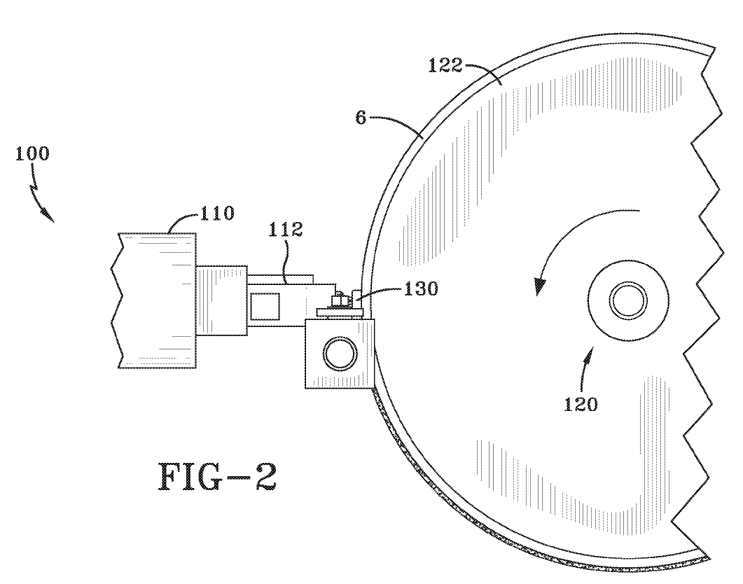

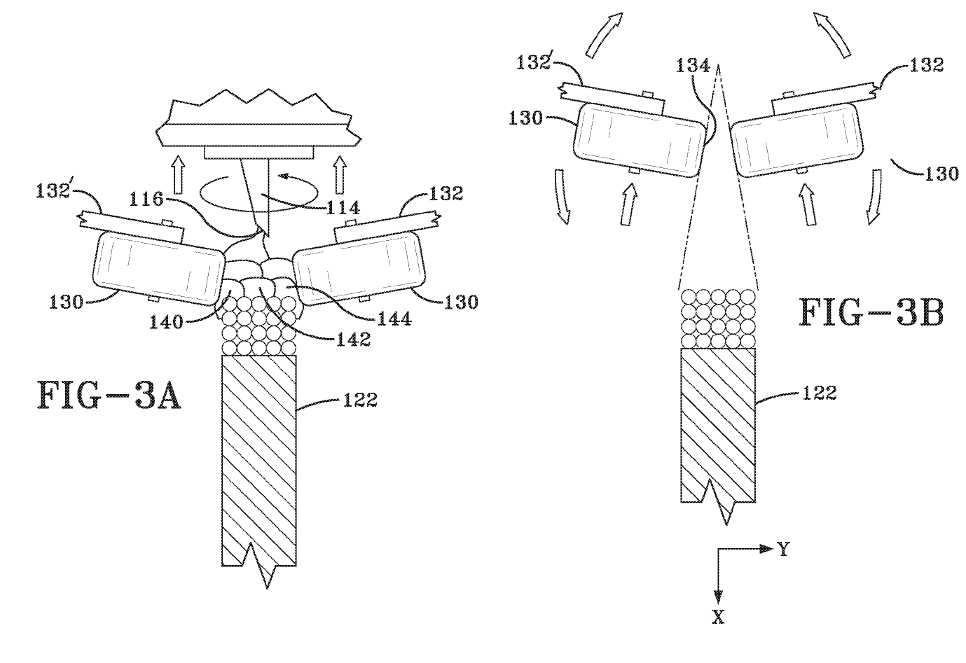

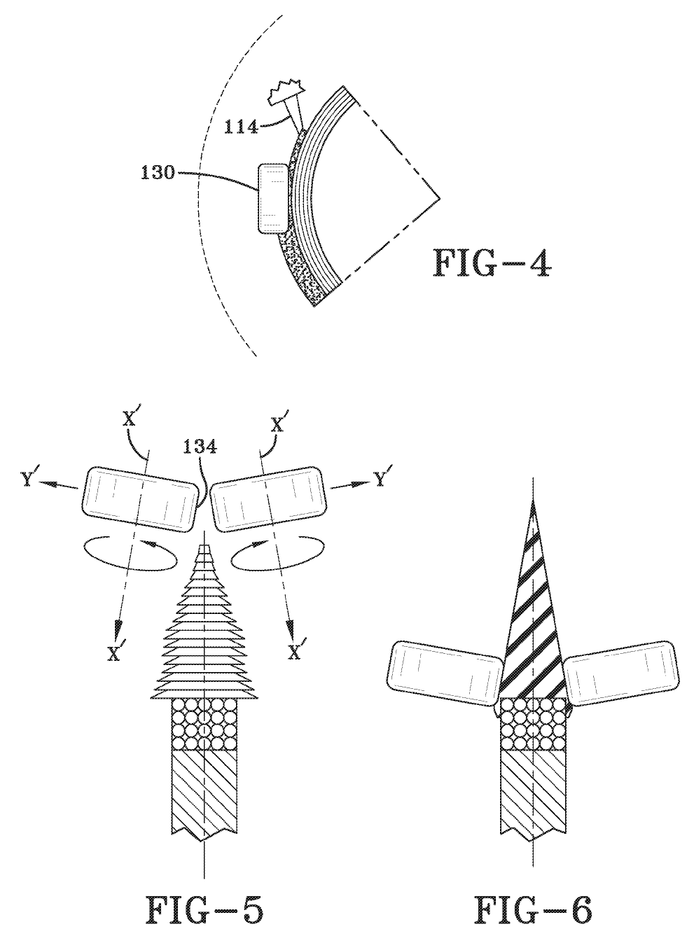

The method of forming the bead apex assembly may now be described. First, an annular bead is mounted and secured onto the bead holder such that the outer radial bead surface is unrestricted. The bead holder is rotated to a desired speed. The nozzle of the extruder apparatus is positioned adjacent the bead bundle for application of a thin strip of elastomeric material to the outer surface of the annular bead. The elastomeric material is preferably applied in a continuous strip. The elastomeric material penetrates into the bead wire bundle as a result of the high pressure of the rubber being released from the extruder nozzle. As shown in FIG. 3, the strip of the first rotation or pass is identified as 140. After the first pass or first full rotation, the nozzle is translated a small amount in the Y direction and a second pass (or second full rotation) of the strip 142 is applied adjacent to the first pass. The second pass 142 of the strip may overlap the first pass 140. A third pass of the strip 144 is then applied, which may or may not overlap the second pass 142. A computer software program may be used to model the most efficient layout of the strip passes to closely approximate the final apex shape as efficiently as possible. The computer software may communicate with a computer controller to coordinate the motion of the gear pump extruder, the rollers 130 translation, rotation and pivot motion and the bead holder rotation and translation.

While the apex is being formed by one or more of the strip passes, the rollers 130 are rotated such that the outer roller surface engages a respective side edge of the apex. The rollers may be pivoted or tilted slightly so that the outer roller surface 134 is perpendicular to the side edge of the apex. Sufficient pressure is applied by the forming rollers to the apex outer surface in order to smooth the outer side edge surface of the apex, as shown in FIG. 5. The rollers are moved along the apex outer surface in order to smooth the entire outer side edge of the apex. After the side edges of the apex are sufficiently smooth, the apex and bead assembly is removed from the bead holder and is ready to be mounted in a tire.

Alternatively, the apex may be shaped by the rollers 130 after the apex has been sufficiently formed by all of the desired passes.

The apex material is preferably formed of a rubber or elastomeric compound having a G′ in the range of about 150 to about 350 kPa, and more preferably in the range of about 190 to about 310 kPa. Unless otherwise noted, all G′ values are measured on an uncured rubber sample at a sample temperature of 190 deg C, at a measurement frequency of 10 Hz and at a strain amplitude of 15%. The rubber sample is taken from a cured tire manufactured to the desired manufacturer specifications. For the purposes of this invention, the storage modulus property G′ is a viscoelastic property of a rubber composition and may be determined by a dynamic mechanical analyzer over a range of frequencies, temperature and strain amplitude. One example of a dynamic mechanical analyzer (DMA) suitable for measuring G′, G″ is model number DMA +450 sold by the 01-dB Metravib company. The DMA instrument uses dynamic mechanical analysis to evaluate rubber compositions. A cured sample of the respective rubber composition is subjected to a precisely controlled dynamic excitation (frequency and amplitude) at a frequency (Hertz) and temperature (° C.) and the sample stress response is observed by the instrument. The observed sample response can be separated, by the instrument, into viscous or loss modulus (G″) and elastic or storage modulus (G′) components. Unless otherwise indicated, all G″ are measured at the same conditions as G′.

Other annular components could also be made by the invention such as chafers, sidewall, etc. Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1-7. (canceled)

8. An apparatus for forming a tire apex and bead wire assembly; the apparatus comprising:
a rotatable bead holder for securing the bead wire thereon, means for rotating the bead wire and bead holder;
an extruder positioned adjacent the bead wire for extruding one or more passes of a continuous strip of elastomeric material onto the outer surface of the bead; and
two opposed rollers positioned adjacent the extruder outlet and the bead wire holder, wherein the rollers are rotatably mounted about a first axis and positioned for shaping the one or more passes of elastomeric material to a predetermined profile.

9. The apparatus of claim 8 wherein each roller is pivotable about its rotational axis.

10. The apparatus of claim 8 wherein each roller is independently pivotable about its rotational axis.

11. The apparatus of claim 8 wherein each roller is independently translatable along its rotational axis.

12. The apparatus of claim 8 wherein the extruder has an outlet nozzle, and wherein the outlet nozzle is rotatable.

13. An apparatus for forming a an elastomeric component; the apparatus comprising:
a rotatable holder for securing the elastomeric component thereon;
means for rotating the holder;
an extruder positioned adjacent the holder for extruding one or more passes of a continuous strip of elastomeric material onto the outer surface of the holder; and
two opposed rollers positioned adjacent the extruder outlet and the holder, wherein the rollers are rotatably mounted about a first axis and positioned for shaping the one or more passes of elastomeric material to a predetermined profile.

14. The apparatus of claim 13 wherein each roller is pivotable about its rotational axis.

15. The apparatus of claim 13 wherein each roller is independently pivotable about its rotational axis.

16. The apparatus of claim 13 wherein each roller is independently translatable along its rotational axis.

17. The apparatus of claim 13 wherein the extruder has an outlet nozzle, and wherein the outlet nozzle is rotatable.
